(19) United States
(12) Patent Application Publication
(10) Pub. No.: US 2021/0231183 A1
(43) Pub. Date: Jul. 29, 2021

(54) BRAKE APPARATUS FOR VEHICLE

(71) Applicant: HYUNDAI MOBIS CO., LTD., Seoul (KR)

(72) Inventor: Choong Sik SHIN, Yongin-si (KR)

(21) Appl. No.: 17/133,434

(22) Filed: Dec. 23, 2020

(30) Foreign Application Priority Data
Jan. 23, 2020 (KR) 10-2020-0009238

(51) Int. Cl. F16D 65/18

(52) U.S. Cl. CPC F16D 65/18; F16D 2121/24

(57) ABSTRACT

A brake apparatus for a vehicle may include: a screw bar positioned in a caliper body, and rotated by power received from a motor part; a nut part configured to cover an outside of the screw bar, engaged and coupled with the screw bar, and rotated and moved toward a brake disk by a rotation of the screw bar; an O-ring part disposed in a sealing space which covers the screw bar of the caliper body, and contacted with the screw bar; and a backup ring part disposed in the sealing space, abutting on the O-ring part on an opposite side of the brake disk, and having a width that increases as a portion of the backup ring part, facing the O-ring part, is away from the O-ring part.

### CROSS-REFERENCE TO RELATED APPLICATION

This application claims priority from and the benefit of Korean Patent Application No. 10-2020-0009238, filed on Jan. 23, 2020, which is hereby incorporated by reference for all purposes as if set forth herein.

### BACKGROUND

### Field

Exemplary embodiments of the present disclosure relate to a brake apparatus for a vehicle, and more particularly, to a brake apparatus for a vehicle, which can prevent damage to an O-ring part.

### Discussion of the Background

In general, an EPB (Electronic Parking Brake) of a vehicle converts a rotational force of a driving motor into a linear motion by using a screw and nut, in order to pressurize a piston. The pressurized piston presses a brake pad with a friction member against a wheel disk, thereby generating a braking force.

The conventional EPB includes a bearing for reducing a rotation load and an O-ring and backup ring for sealing, in addition to the screw, the nut and the piston. However, when the screw and the nut are operated to generate a braking force, a caliper body is elastically deformed to make a difference in angle between the central axes of the screw and the caliper body, and a gap is formed between the rear surface of the O-ring and the screw and between the backup ring and the screw. In this case, while the O-ring is inserted into the gap between the rear surface of the O-ring and the screw or between the backup ring and the screw, the O-ring may be damaged. Therefore, there is a need for an apparatus capable of solving the problem.

The related art of the present disclosure is disclosed in Korean Patent No. 10-1184575 entitled “Electronic Disk Brake System” and registered on Sep. 14, 2012.

### SUMMARY

Various embodiments are directed to a brake apparatus for a vehicle, which can prevent damage to an O-ring part.

In an embodiment, a brake apparatus for a vehicle may include: a screw bar positioned in a caliper body, and rotated by power received from a motor part; a nut part configured to cover an outside of the screw bar, engaged and coupled with the screw bar, and rotated and moved toward a brake disk by a rotation of the screw bar; an O-ring part disposed in a sealing space which covers the screw bar of the caliper body, and contacted with the screw bar; and a backup ring part disposed in the sealing space, abutting on the O-ring part on an opposite side of the brake disk, and having a width that increases as a portion of the backup ring part, facing the O-ring part, is away from the O-ring part.

The backup ring part may include: a backup ring body configured to surround the outside of the screw bar; and a backup-ring inclined part connected to the backup ring body, and formed in a pillar shape whose width increases as the backup-ring inclined part is away from the O-ring part. The O-ring part may be elastically deformed to correspond to the backup-ring inclined part during a relative motion between the caliper body and the screw bar, and pressurizes the backup-ring inclined part toward the screw bar.

The backup-ring inclined part may have an inclined surface abutting on the O-ring part.

The backup-ring inclined part may be formed in a pillar shape whose width increases as the backup-ring inclined part is away from the O-ring part. During a relative motion between the caliper body and the screw bar, the O-ring part may be elastically deformed along the backup-ring inclined part, and pressurize the backup-ring inclined part.

The screw bar may include: a first screw bar engaged and coupled with the nut part; a second screw bar connected to the first screw bar and the motor part, and having an outside surrounded by the O-ring part and the backup ring part; and a third screw bar extended from a circumference of the second screw bar to the outside of the second screw bar.

The brake apparatus may further include a piston part installed in a shape to cover an outside of the nut part, and moved with the nut part so as to pressurize a pad member.

The pad member may include: a back plate disposed to face the piston part, and pressurized by the piston part; and a friction member coupled to a surface of the back plate, facing the brake disk.

The piston part may be formed in a cylindrical shape, one side of the piston part, into which the screw bar is inserted, may be open, and the other side of the piston part, facing the pad member, may be closed.

When the screw bar is rotated in a predetermined direction, the nut part may be moved toward the brake disk or the opposite side of the brake disk according to a rotation direction of the screw bar, while converting a rotational motion of the screw bar into a linear motion.

The O-ring part may be elastically deformed during a relative motion between the caliper body and the screw bar, and pressurize the backup ring part toward the screw bar such that the backup ring part is contacted with the screw bar.

In the brake apparatus for a vehicle in accordance with the embodiment of the present disclosure, the backup ring part may have a width that increases as a portion of the backup ring part, facing the O-ring part, is away from the O-ring part. Thus, during a relative motion between the caliper body and the screw bar, the O-ring part may be elastically deformed to pressurize the backup ring part toward the screw bar, such that the backup ring part is contacted with the screw bar. Therefore, it is possible to prevent a gap from being formed between the screw bar and the backup ring part, thereby preventing damage to the O-ring part, which may occur when the O-ring part is inserted into a gap between the screw bar and the backup ring part.

### BRIEF DESCRIPTION OF THE DRAWINGS

FIG. 1 is a cross-sectional view illustrating a brake apparatus for a vehicle in accordance with an embodiment of the present disclosure.

FIG. 2 is a cross-sectional view illustrating main parts of FIG. 1.

FIG. 3 is a perspective view illustrating a screw bar, a nut part, an O-ring part and a backup ring part of the brake apparatus for a vehicle in accordance with the embodiment of the present disclosure.

FIG. 4 is a half-cross sectional view illustrating the backup ring part of the brake apparatus for a vehicle in accordance with the embodiment of the present disclosure.

FIGS. 5 and 6 are diagrams illustrating an operation of the brake apparatus for a vehicle in accordance with the embodiment of the present disclosure.

FIGS. 7A and 7B are diagrams schematically illustrating that the O-ring part and the backup ring part of the brake apparatus for a vehicle in accordance with the embodiment of the present disclosure are deformed to prevent a gap from being formed between the backup ring and the screw bar.

### DETAILED DESCRIPTION OF THE ILLUSTRATED EMBODIMENTS

Hereinafter, a brake apparatus for a vehicle will be described below with reference to the accompanying drawings through various exemplary embodiments.

It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

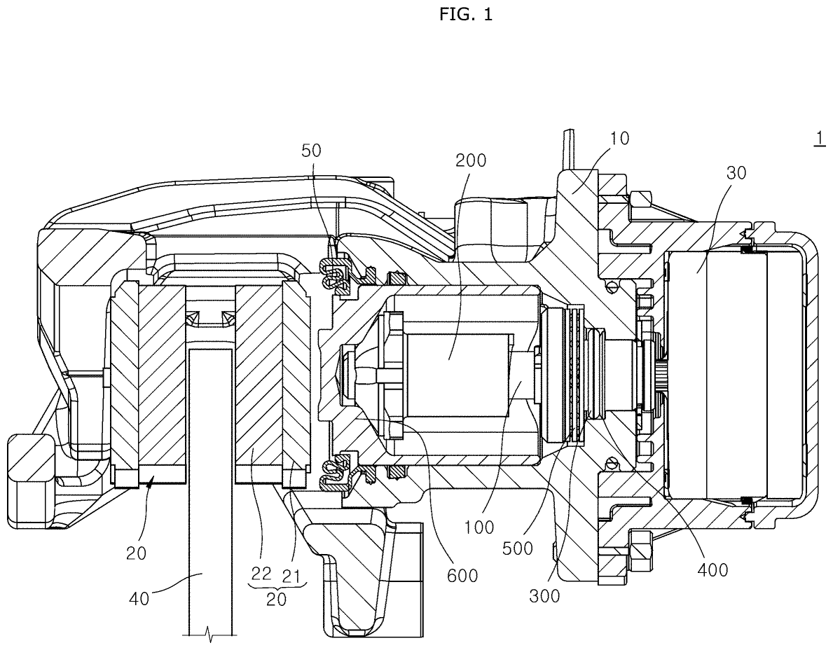

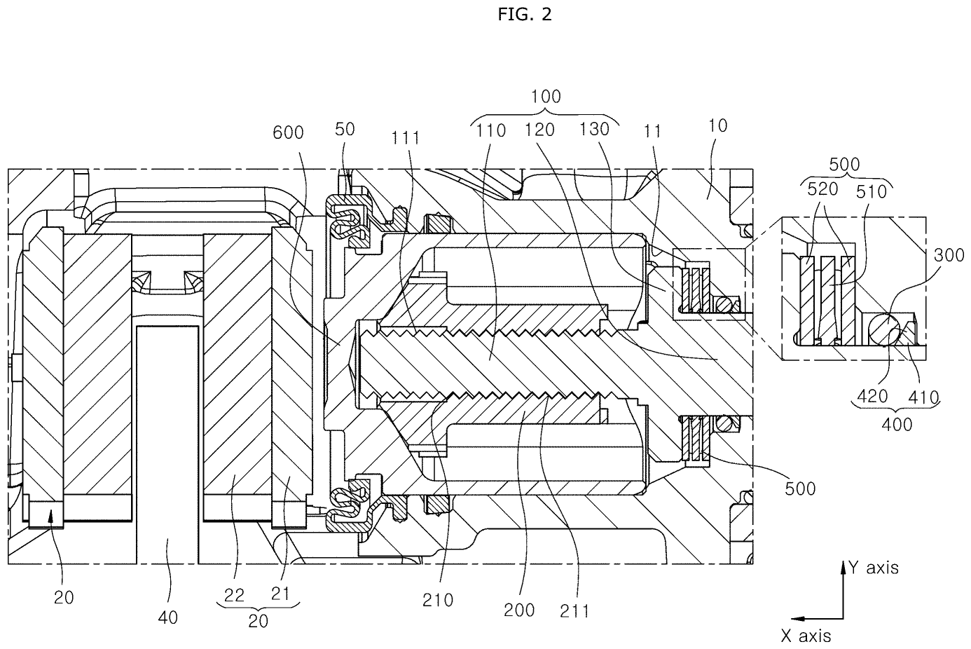

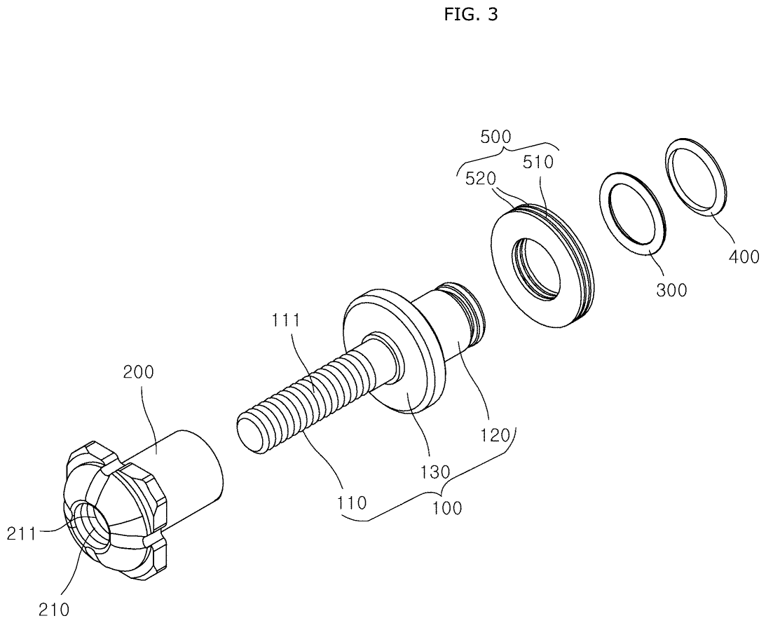

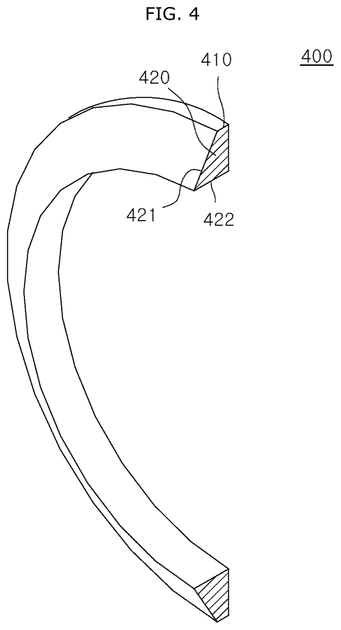

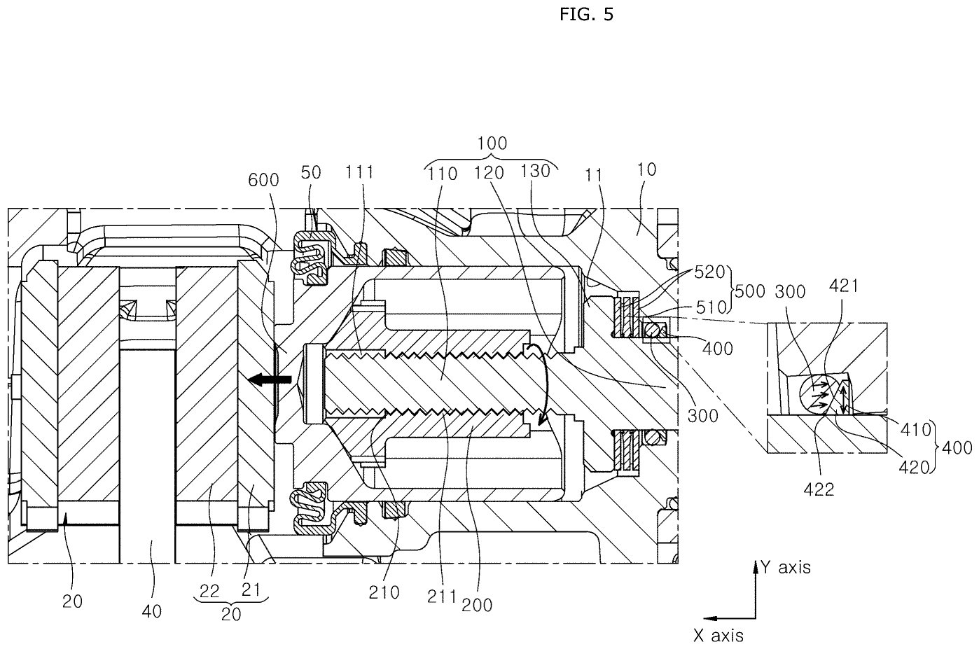

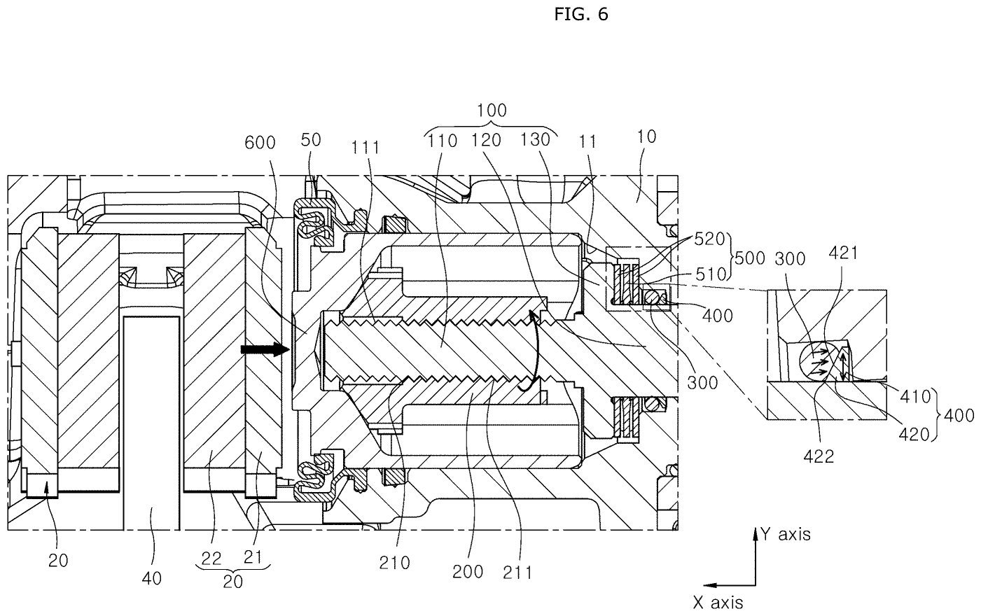

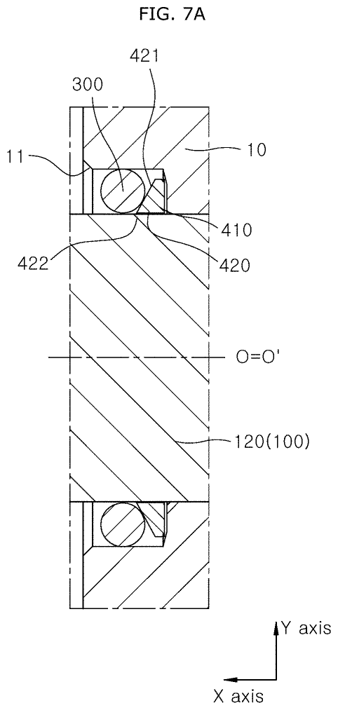

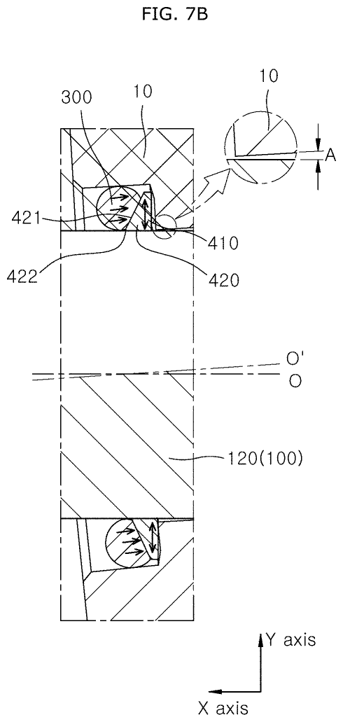

FIG. 1 is a cross-sectional view illustrating a brake apparatus for a vehicle in accordance with an embodiment of the present disclosure, FIG. 2 is a cross-sectional view illustrating main parts of FIG. 1, FIG. 3 is a perspective view illustrating a screw bar, a nut part, an O-ring part and a backup ring part of the brake apparatus for a vehicle in accordance with the embodiment of the present disclosure, FIG. 4 is a half-cross sectional view illustrating the backup ring part of the brake apparatus for a vehicle in accordance with the embodiment of the present disclosure, FIGS. 5 and 6 are diagrams illustrating an operation of the brake apparatus for a vehicle in accordance with the embodiment of the present disclosure, and FIGS. 7A and 7B are diagrams schematically illustrating that the O-ring part and the backup ring part of the brake apparatus for a vehicle in accordance with the embodiment of the present disclosure are deformed to prevent a gap from being formed between the backup ring and the screw bar.

Referring to FIGS. 1 to 4, a brake apparatus 1 for a vehicle in accordance with an embodiment of the present disclosure includes a screw bar 100, a nut part 200, an O-ring part 300, a backup ring part 400, a bearing part 500 and a piston part 600. The screw bar 100 is positioned in a caliper body 10, and rotated by power received from a motor part 30. For example, the motor part 30 includes a motor and a plurality of gears, which are not illustrated. Any one of the gears is connected to the motor, and another one of the gears is connected to the screw bar 100. The gears receive a rotational force from the motor, and rotate the screw bar 100. At this time, the screw bar 100 is formed in a rod shape and inserted into the nut part 200. The screw bar 100 has a male screw thread 111 formed on the outside thereof, and is rotated by the rotational force received from the motor.

Between the piston part 600 and the caliper body 10, a sealing member 50 may be installed. As the sealing member 50, various types of sealing members may be used as long as the sealing members can perform a sealing action. The sealing member 50 is installed in a cylinder 11 of the caliper body 10 facing the piston part 600.

The nut part 200 covers the outside of the screw bar 100, is engaged and coupled with the screw bar 100, and moved toward a brake disk 40 while rotated by the rotation of the screw bar 100. The nut part 200 has a nut hole 210 formed therein, the nut hole 210 having a female screw thread 211 formed therein, the female screw thread 211 being engaged and coupled with the male screw thread 111 of the screw bar 100.

Specifically, when the screw bar 100 is rotated in a predetermined direction, the nut part 200 is moved toward the brake disk 40, while converting a rotational motion of the screw bar 100 into a linear motion. On the contrary, when the screw bar 100 is rotated in the opposite direction of the predetermined direction, the nut part 200 is moved toward the opposite side of the brake disk 40.

The O-ring part 300 is disposed in a sealing space 12 to cover the screw bar 100 of the caliper body 10, and contacted with the screw bar 100. The O-ring part 300 is made of an elastic material. The O-ring part 300 is disposed in the sealing space 12 of the caliper body 10, and elastically deformed to pressurize the backup ring part 400 toward the screw bar 100, during a relative motion between the caliper body 10 and the screw bar 100. Thus, the backup ring part 400 is contacted with the screw bar 100.

The backup ring part 400 is disposed in the sealing space 12, abuts the O-ring part 300 on the opposite side of the brake disk 40, and has a width that increases as a portion of the backup ring part 400, facing the O-ring part 300, is away from the O-ring part 300. At this time, the width indicates the length of the backup ring part 400 in the Y-axis direction (based on FIG. 2).

The backup ring part 400 includes a backup ring body 410 and a backup-ring inclined part 420. The backup ring body 410 surrounds the outside of the screw bar 100. The backup ring body 410 is formed in a ring shape with a constant width (see FIGS. 1 to 3).

The backup-ring inclined part 420 is connected to the backup ring body 410, and formed in a pillar shape whose width increases as the backup-ring inclined part 420 is away from the O-ring part 300. That is, the backup-ring inclined part 420 is formed in a cone shape, and has a circular hole (not illustrated) through which the screw bar 100 passes.

During a relative motion between the caliper body 10 and the screw bar 100, the O-ring part 300 is elastically deformed to correspond to the backup-ring inclined part 420, and pressurizes the backup-ring inclined part 420 toward the screw bar 100 such that the backup-ring inclined part 420 is contacted with the screw bar 100. The backup-ring inclined part 420 may be made of an elastic material, elastically deformed by the pressurization of the O-ring part 300 so as to be elongated in a direction crossing the screw bar 100, and contacted with the screw bar 100. That is, the backup-ring inclined part 420 may be elastically deformed and elongated in the Y-axis direction (based on FIG. 5) by the pressurization of the O-ring part 300, and contacted with the screw bar 100.

The backup-ring inclined part 420 has an inclined surface 421 contacted with the O-ring part 300. The backup-ring inclined part 420 includes the inclined surface 421 contacted with the O-ring part 300 and a contact surface 422 contacted with the screw bar 100. The backup ring body 410 is also made of an elastic material.

As the backup-ring inclined part 420 is formed in a pillar shape whose width increases as the backup-ring inclined part 420 is away from the O-ring part 300, the O-ring part 300 may be elastically deformed along the backup-ring inclined part 420 during a relative motion between the caliper body 10 and the screw bar 100, and easily pressurize the backup-ring inclined part 420 in the Y-axis direction (based on FIG. 5). Therefore, the backup-ring inclined part 420 may be contacted with the screw bar 100. Thus, a gap may be prevented from being formed between the screw bar 100 and the backup-ring inclined part 420, which makes it possible to prevent the O-ring part 300 from being inserted into a gap formed between the screw bar 100 and the backup-ring inclined part 420. As a result, the O-ring part 300 may be prevented from being damaged.

The bearing part 500 surrounds the outside of the screw bar 100, and is disposed to face the O-ring part 300. The bearing part 500 includes a bearing 510 and a bearing plate 520. The bearing 510 surrounds the outside of the screw bar 100, and facilitates the rotation of the screw bar 100. The bearing plate 520 is disposed on either side of the bearing 510, and supports the bearing 510.

The screw bar 100 includes a first screw bar 110, a second screw bar 120 and a third screw bar 130. The first screw bar 110 is engaged and coupled with the nut part 200. The first screw bar 110 is formed in a pillar shape, and has the male screw thread 111 formed on the outer surface thereof, the male screw thread 111 being engaged and coupled with the female screw thread 211.

The second screw bar 120 is connected to the first screw bar 110 and the motor part 30, and the outside thereof is surrounded by the O-ring part 300 and the backup ring part 400. The second screw bar 120 is formed in a pillar shape, and has one end connected to the first screw bar 110 and the other end connected to the motor part 30.

The third screw bar 130 is extended from the circumference of the second screw bar 120 to the outside so as to face the bearing part 500. The third screw bar 130 is formed in a ring shape, and faces the bearing plate 520 of the bearing part 500.

The piston part 600 is installed in a shape to cover the outside of the nut part 200, and moved with the nut part 200 so as to pressurize a pad member 20. The piston part 600 is moved toward the brake disk 40 or the opposite side of the brake disk 40 by the pressurization of the nut part 200 on the cylinder 11 of the caliper body 10.

The pad member 20 includes a back plate 21 and a friction member 22. The back plate 21 is disposed to face the piston part 600, and pressurized by the piston part 600. The friction member 22 is coupled to a surface of the back plate 21, facing the brake disk 40. The friction member 22 can be contacted with the brake disk 40.

When the piston part 600 pressurizes the pad member 20, the pad member 20 is contacted with the brake disk 40 to generate a braking force. That is, when the piston part 600 pressurizes the back plate 21 of the pad member 20, the friction member 22 of the pad member 20 is contacted with the brake disk 40. The piston part 600 is formed in a cylindrical shape. One side of the piston part 600, into which the screw bar 100 is inserted, is open, and the other side of the piston part 600, facing the pad member 20, is closed.

Hereafter, the operation and effect of the brake apparatus for a vehicle in accordance with the embodiment of the present disclosure will be described with reference to FIGS. 5 and 7.

When a braking force is generated by the brake apparatus 1 for a vehicle, the screw bar 100 is rotated in a predetermined direction by power received from the motor part 30, and the nut part 200 engaged and coupled with the screw bar 100 is rotated in the predetermined direction and moved toward the piston part 600.

The nut part 200 is contacted with the inside of the piston part 600, and pressurizes the piston part 600 toward the pad member 20. Therefore, the piston part 600 may pressurize the pad member 20, and a braking force may be generated while the pad member 20 is contacted with the brake disk 40. At this time, the O-ring part 300 surrounding the outer circumference of the screw bar 100 is elastically deformed to correspond to the backup-ring inclined part 420 of the backup ring part 400, and pressurizes the backup-ring inclined part 420 of the backup ring part 400 toward the screw bar 100. Thus, the backup-ring inclined part 420 of the backup ring part 400 is contacted with the screw bar 100 (see FIG. 5).

When the braking force is released to rotate the screw bar 100 in the opposite direction of the predetermined direction, the nut part 200 engaged and coupled with the screw bar 100 is rotated in the opposite direction of the predetermined direction and moved to the opposite side of the piston part 600. That is, the nut part 200 is spaced apart from the piston part 600. As the pressurization of the pad member 20 by the piston part 600 is released and the pad member 20 is not contacted with the brake disk 40, the braking force is released. Even at this time, while the O-ring part 300 is elastically deformed to correspond to the backup-ring inclined part 420 of the backup ring part 400, the backup-ring inclined part 420 of the backup ring part 400 is pressurized toward the screw bar 100, and contacted with the screw bar 100 (see FIG. 6).

Furthermore, when a braking force is generated or released as illustrated in FIGS. 7A and 7B, i.e. during a relative motion between the caliper body 10 and the screw bar 100, the caliper body 10 is elastically deformed and tilted to form an angle between the axis O′ of the caliper body 10 and the rotation axis O of the screw bar 100, thereby increasing the gap between the screw bar 100 and the caliper body 10. However, the O-ring part 300 is elastically deformed to correspond to the inclined surface 421 of the backup-ring inclined part 420, and presses the backup-ring inclined part 420 toward the screw bar 100. Thus, the backup-ring inclined part 420 is contacted with the screw bar 100. Thus, the gap between the backup-ring inclined part 420 of the backup ring part 400 and the screw bar 100 may be removed to prevent the O-ring part 300 from being inserted into the gap between the screw bar 100 and the backup-ring inclined part 420 of the backup ring part 400, which makes it possible to prevent damage to the O-ring part 300.

As described above, when a braking force is generated or released, the backup ring part 400 of the brake apparatus 1 for a vehicle in accordance with the embodiment of the present disclosure is contacted with the screw bar 100 by the pressurization of the O-ring part 300, thereby preventing a gap from being formed between the screw bar 100 and the backup-ring inclined part 420 of the backup ring part 400. Thus, it is possible to prevent damage to the O-ring part 300, which may occur when the O-ring part 300 is inserted into a gap between the screw bar 100 and the backup ring part 400.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake apparatus for a vehicle, comprising:
a screw bar positioned in a caliper body, and rotated by power received from a motor part;
a nut part configured to cover an outside of the screw bar, engaged and coupled with the screw bar, and rotated and moved toward a brake disk by a rotation of the screw bar;
an O-ring part disposed in a sealing space which covers the screw bar of the caliper body, and contacted with the screw bar; and
a backup ring part disposed in the sealing space, abutting on the O-ring part on an opposite side of the brake disk, and having a width that increases as a portion of the backup ring part, facing the O-ring part, is away from the O-ring part.

2. The brake apparatus of claim 1, wherein the backup ring part comprises:
a backup ring body configured to surround the outside of the screw bar; and
a backup-ring inclined part connected to the backup ring body, and formed in a pillar shape whose width increases as the backup-ring inclined part is away from the O-ring part,
wherein the O-ring part is elastically deformed to correspond to the backup-ring inclined part during a relative motion between the caliper body and the screw bar, and pressurizes the backup-ring inclined part toward the screw bar.

3. The brake apparatus of claim 2, wherein the backup-ring inclined part has an inclined surface abutting on the O-ring part.

4. The brake apparatus of claim 3, wherein the backup-ring inclined part is formed in a pillar shape whose width increases as the backup-ring inclined part is away from the O-ring part, and
during a relative motion between the caliper body and the screw bar, the O-ring part is elastically deformed along the backup-ring inclined part, and pressurizes the backup-ring inclined part.

5. The brake apparatus of claim 1, wherein the screw bar comprises:
a first screw bar engaged and coupled with the nut part;
a second screw bar connected to the first screw bar and the motor part, and having an outside surrounded by the O-ring part and the backup ring part; and
a third screw bar extended from a circumference of the second screw bar to the outside of the second screw bar.

6. The brake apparatus of claim 1, further comprising a piston part installed in a shape to cover an outside of the nut part, and moved with the nut part so as to pressurize a pad member.

7. The brake apparatus of claim 6, wherein the pad member comprises:
a back plate disposed to face the piston part, and pressurized by the piston part; and
a friction member coupled to a surface of the back plate, facing the brake disk.

8. The brake apparatus of claim 7, wherein the piston part is formed in a cylindrical shape, one side of the piston part, into which the screw bar is inserted, is open, and the other side of the piston part, facing the pad member, is closed.

9. The brake apparatus of claim 1, wherein when the screw bar is rotated in a predetermined direction, the nut part is moved toward the brake disk or the opposite side of the brake disk according to a rotation direction of the screw bar, while converting a rotational motion of the screw bar into a linear motion.

10. The brake apparatus of claim 1, wherein the O-ring part is elastically deformed during a relative motion between the caliper body and the screw bar, and pressurizes the backup ring part toward the screw bar such that the backup ring part is contacted with the screw bar.
